(19) United States
(12) Patent Application Publication
(10) Pub. No.: US 2019/0114130 A1
(43) Pub. Date: Apr. 18, 2019

(54) INDUSTRIAL PROCESS CONTROL SYSTEM

(71) Applicant: Valmet Automation Oy, Espoo (FI)

(72) Inventors: Hannu PAUNONEN, Tampere (FI); Jouni RUOTSALAINEN, Tampere (FI); Lauri LEHTIKUNNAS, Tampere (FI)

(21) Appl. No.: 15/786,748

(22) Filed: Oct. 18, 2017

(51) Int. Cl. G06F 3/14; G09G 5/36; G06Q 10/06

(52) U.S. Cl. CPC G06F 3/14; G05B 23/027; G06Q 10/063; G09G 5/363

(57) ABSTRACT

An industrial process control system includes a graphical user interface for monitoring and controlling an operation of an industrial process. The graphical user interface includes a main process page window for displaying a graphical illustration of the industrial process and a group of auxiliary process page windows displaying a graphical illustration of at least one subprocess or process component of the industrial process. The graphical illustration of the industrial process, at least one subprocess or at least one process component is operationally connected to the respective process, subprocess or process component for providing at least one of monitoring and controlling of an operation of the respective process, subprocess or process component. At least one process page window includes at least one operator configurable region to be displayed at the respective process, subprocess or process component for visualizing information describing the operation of the process, subprocess or process component in response to a selection of the information to be displayed.

### FIELD OF THE INVENTION

The present invention relates to an industrial process control system comprising a graphical user interface for monitoring and controlling an operation of an industrial process.

The present invention relates also to a method of generating a process page window in the industrial process control system comprising the graphical user interface for monitoring and controlling the operation of the industrial process.

### BACKGROUND INFORMATION

Graphical user interfaces in industrial process control systems for monitoring and controlling operations in industrial processes comprise typically a main process page window for displaying a graphical illustration of the industrial process as well as a number of auxiliary process page windows at least some of which are arranged to display a graphical illustration of at least one subprocess of the industrial process or at least one process component of the industrial process. In the graphical user interfaces for industrial process control systems a graphical illustration of the industrial process, at least one subprocess or at least one process component is operationally connected to the respective process, subprocess or process component for providing at least one of monitoring and controlling of an operation of the respective process, subprocess or process component through that respective graphical illustration in the graphical user interface.

The graphical illustrations of the industrial processes, subprocesses and process components are often provided with data items describing information for example about variables to be measured, set values for the variables to be measured and indications about abnormal situations, such as alarms, in the operation of the industrial process. A problem relating to the presently available industrial process control systems and graphical user interfaces used therein is, however, that a way of presentation of the information describing the operation of the process, subprocess or the process component is fixed.

### SUMMARY

An object of the invention is to provide a novel industrial process control system comprising a graphical user interface for monitoring and controlling an operation of an industrial process.

The invention is characterized by the features of the independent claims.

The operator configurable region provides for the operator a portion in the process page window, wherein the operator may freely inspect and/or supply information relating to the respective process, subprocess and/or process component. In the operator configurable region the operator may also define which process monitoring information is to be monitored and/or supplied in the respective operator configurable region.

According to an embodiment the graphical user interface in the industrial process control system comprises a main process page window for displaying a graphical illustration of the industrial process and a group of auxiliary process page windows, wherein at least some of the auxiliary process page windows are arranged to display a graphical illustration of at least one subprocess or at least one process component of the industrial process, and wherein the graphical illustration of the industrial process, at least one subprocess or at least one process component is operationally connected to the respective process, subprocess or process component for providing at least one of monitoring and controlling of an operation of the respective process, subprocess or process component through the respective graphical illustration of the graphical user interface, and wherein at least one process page window comprises at least one operator configurable region to be displayed at the respective process, subprocess or process component for visualizing information describing the operation of the process, subprocess or process component in response to a selection of the information to be displayed.

According to an embodiment in a method of generating a process page window in a graphical user interface in an industrial process control system, wherein the graphical user interface comprises a main process page window for displaying a graphical illustration of the industrial process and a group of auxiliary process page windows, wherein at least some of the auxiliary process page windows are arranged to display a graphical illustration of at least one subprocess or at least one process component of the industrial process, and wherein the graphical illustration of the industrial process, at least one subprocess or at least one process component is operationally connected to the respective process, subprocess or process component for providing at least one of monitoring and controlling of an operation of the respective process, subprocess or process component through the respective graphical illustration of the graphical user interface, at least one operator configurable region to be displayed at the respective process, subprocess or process component for visualizing information describing the operation of the process, subprocess or process component in response to a selection of the information to be displayed is generated in at least one process page window, and the process page window comprising the configurable window is stored into the group of the process page windows in the graphical user interface.

According to an embodiment the process page window comprising the at least one operator configurable region comprises a first layer and a second layer to be at least partly superimposed on top of the first layer, and that the first layer is arranged to comprise the industrial process, subprocess or process component and the second layer is configured to comprise the operator configurable region to be displayed at the respective process, subprocess or process component.

According to an embodiment at least one of a size and shape of the operator configurable region is changeable in response to an operation of an operator to change the at least one of the size and shape of the operator configurable region.

According to an embodiment a content of the operator configurable region is to be updated in response to an operation of an operator to update the content of the operator configurable region.

According to an embodiment the operator configurable region comprises at least one first selector for selecting a way of presentation of the information to be displayed in the operator configurable region in response to a selection of an operator.

According to an embodiment the operator configurable region comprises at least one second selector for determining a time period during which time period the information taken place is to be displayed in response to a selection of an operator.

According to an embodiment the information to be displayed in the operator configurable region comprises process data describing at least one of measurement information relating to the industrial process, subprocess or process component; setup information relating to the industrial process, subprocess or process component; control information relating to the industrial process, subprocess or process component; notes relating to the industrial process, subprocess or process component; and alarm information relating to the industrial process, subprocess or process component.

According to an embodiment the alarm information comprises a visual representation of an alarm chain of interdependent alarms taken place in the industrial process, subprocess or process component.

According to an embodiment the visual representation of the alarm chain of the interdependent alarms comprises a number of successive pointers, wherein each pointer starts from a position of the industrial process, subprocess or process component where the at least one malfunction initiating the alarm was appeared and ending to a position of the industrial process, subprocess or process component where the malfunction initiating the first alarm initiated at least one subsequent second alarm.

According to an embodiment a snap-shot comprising at least one information describing the operation of the process, subprocess or process component is taken in response to a respective command received and the snap-shot taken is stored into a data storage forming part of the industrial process control system.

According to an embodiment a snap-shot comprising at least one information describing the operation of the process, subprocess or process component is taken in response to a respective command received, at least one previously taken snap-shop is retrieved from the data storage and the last snap-shot taken is compared to at least one previously taken snap-shot retrieved from the data storage.

### BRIEF DESCRIPTION OF THE DRAWINGS

In the following the invention will be described in greater detail by means of preferred embodiments with reference to the accompanying drawings, in which

FIG. 1 is a schematic view of an operating environment of an industrial process;

FIG. 2 is a schematic view of a main process page window for displaying a graphical illustration of an industrial process;

FIG. 3 is a schematic view of an auxiliary process page window for displaying a graphical illustration of a subprocess of the industrial process;

FIG. 4 is a schematic view of an auxiliary process page window for displaying a graphical illustration of a process component of the industrial process;

FIG. 5 is a schematic view of an embodiment of an auxiliary process page window for displaying a graphical illustration of a process component of the industrial process;

FIG. 6 is a schematic view of an embodiment of an auxiliary process page window for displaying a graphical illustration of a process component of the industrial process;

FIG. 7 is a schematic view of an embodiment of an auxiliary process page window for displaying a graphical illustration of a process component of the industrial process;

FIG. 8 is a schematic view of an embodiment of an operator configurable region in an auxiliary process page window for displaying a graphical illustration of a process component of the industrial process;

FIG. 9 is a schematic view of an embodiment of an operator configurable region;

FIG. 10 is a schematic view of an embodiment of an operator configurable region in an auxiliary process page window for displaying a graphical illustration of a process component of the industrial process;

FIG. 11 is a schematic view of an embodiment of an operator configurable region in a main process page window for displaying a graphical illustration of the industrial process;

FIGS. 12a, 12b, 12c disclose schematically a comparing of snap-shots of values of a controllable variable during different time instants;

FIGS. 13a and 13b disclose schematically a comparing of snap-shots of a subprocess at different time instants.

For the sake of clarity, the figures show some embodiments of the invention in a simplified manner. Like reference numerals identify like elements in the figures.

### DETAILED DESCRIPTION

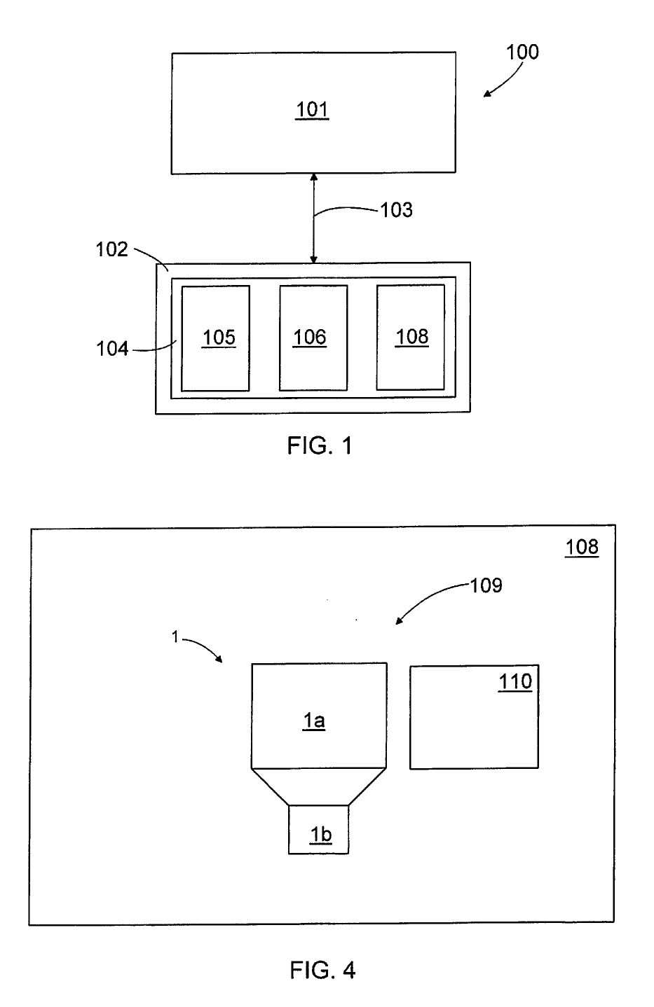

FIG. 1 is a schematic view of an industrial process environment 100. The industrial process environment 100 comprises an industrial process 101, which in the example of FIG. 1 is denoted very schematically by a box drawn with a continuous line.

The industrial process environment 100 further comprises a process control user interface 102 for controlling and monitoring operations in the industrial process 101, as well as a data-communication network shown very schematically with an arrow denoted with reference sign 103 for information or data transfer between the industrial process 101 and the process control user interface 102. The process control user interface 102 comprises necessary hardware and software means through which the monitoring and control of the industrial process 101 may be provided.

The hardware of the process control user interface 102 may for example comprise a process control computer comprising or being connected to a number of input/output units providing necessary connections to the industrial process 101 as well as to devices used either to represent process monitoring information to an operator of the industrial process or to receive process control information provided by the operator. The hardware of the process control user interface 3 may also comprise an extendable amount of memory for storing information relating to the industrial process and monitoring and control operations thereof.

The process monitoring information mentioned above may for example comprise exact numerical data or visually or by means of audio representable information. The devices for presenting this information may for example comprise a number of display means for displaying numerical or graphical information or real-time video information describing the operation of the process or a specific part or point therein, and possible audio means for producing real time sound information recorded at the industrial process at a specific part or point therein.

The process control information mentioned above may for example comprise exact numerical values, such as set values for process control, or additional information describing the operation of the process, such as textually or visually or orally presented notes to be stored into the memory of the process control user interface. The devices for this purpose may comprise a keyboard, a joystick, a camera and a microphone, for instance.

The software of the process control user interface 102 may for example comprise an operating system of the process control computer and a data-communication control software for controlling the data communication between the industrial process 101 and the process control user interface 102 as well as between the process control user interface 102 and devices used either to represent process monitoring information to an operator of the industrial process or to receive process control information provided by the operator. The software of the process control user interface 102 further comprises software for providing a graphical user interface of the industrial process 101.

The hardware and software means used in process control systems and graphical user interfaces used therein are generally known for a person skilled in the art and therefore their general structure and operation are not considered herein in more detail.

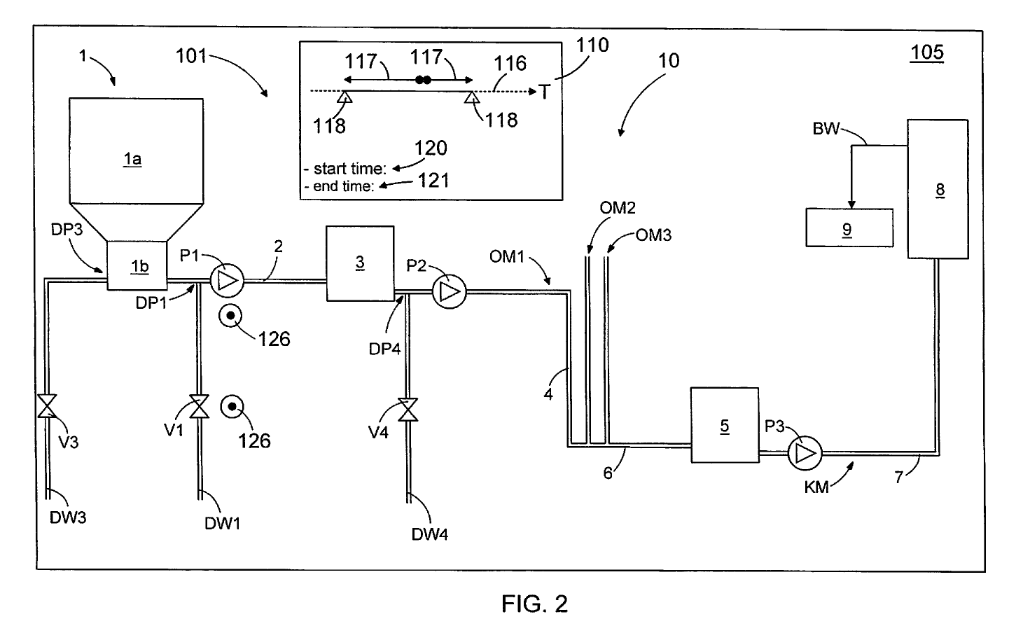

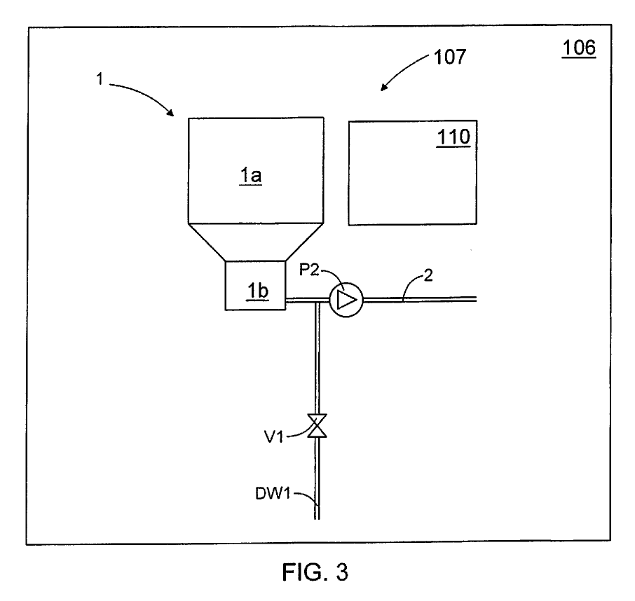

The process control user interface 102 comprises further a graphical user interface 104 for controlling and monitoring the operations in the industrial process 101. The graphical user interface 104 in the solution described herein comprises a number of process page windows illustrating the industrial process and possibly a number of subprocesses and process components thereof. The graphical user interface 104 comprises a main process page window 105 for illustrating or displaying a graphical illustration of the industrial process 101. In FIG. 2 it is disclosed schematically a main process page window 105 of an industrial process 101. The graphical user interface 104 further comprises a group of auxiliary process page windows, at least some of the auxiliary process page windows being arranged to display a graphical illustration of at least one subprocess of the industrial process 101 and/or at least one process component of the industrial process 101. In FIG. 3 it is disclosed schematically a first auxiliary process page window 106 for displaying a graphical illustration of a subprocess 107 of the industrial process 101 and in FIG. 4 it is disclosed schematically a second auxiliary process page window 108 for displaying a graphical illustration of a process component 109 of the industrial process 101.

The graphical illustration of the industrial process 101, at least one subprocess 107 or at least one process component 109 is operationally connected to the respective process 101, subprocess 107 or process component 109 for providing at least one of monitoring and controlling of an operation of the respective process 101, subprocess 107 or process component 109 through the respective graphical illustration in the graphical user interface 104. Furthermore the at least one process page window, i.e. the main process page window 105, the at least one first auxiliary process page window 106 and/or the at least one second process page window 108, comprises at least one operator configurable region 110 to be displayed at the respective process 101, subprocess 107 and/or process component 109 for visualizing information describing the operation of the process 101, subprocess 107 and/or process component 109 in response to a selection of the information to be displayed.

FIG. 2 is a schematic view of a main process page window 105 for displaying a graphical illustration of an industrial process 101. The industrial process 101 displayed in the main process page window 105 of the graphical user interface 104 relates to a paper manufacturing and shows schematically a stock preparation department 10 for a paper machine 8, i.e. stock production and dosing line for a paper machine 8, the paper machine 8 being shown very schematically only by means of a rectangular box. Machine stock KM to be fed to the paper machine 8 is composed of three component stocks OM1, OM2 and OM3, which are mixed with each other. For the sake of clarity, the dosing line of only the first component stock OM1 is shown in its entirety. The dosing lines of the second component stock OM2 and the third component stock OM3 are substantially similar. The dosing line for the first component stock OM1 includes a stock tower 1 acting as the storage chest for the component stock OM1. From the stock tower 1, the first component stock OM1 is fed with a first pump P1 along a feeding pipe 2 to a component stock chest 3 acting as a dosing chest. From the component stock chest 3, the first component stock OM1 is fed with a second pump P2 along a dosing pipe 4 to a main line 6 in the stock preparation, leading to a blending/machine chest 5, to which main line 6 the second and third components stocks OM2, OM3 are led in the same way. The component stocks OM1, OM2 and OM3 start to blend with each other in the main line 6, but more efficient blending of the component stocks OM1, OM2 and OM3 occurs only in the blending/machine chest 5, where efficient blenders are used to blend the component stocks OM1, OM2 and OM3 with each other. From the blending/machine chest 5, the machine stock KM composed of the component stocks OM1, OM2 and OM3 is fed with a third pump P3 along a machine stock dosing pipe 7 to the short circulation of the paper machine 8 and further to a headbox of the paper machine 8 for feeding the paper stock to a wire section of the paper machine 8.

If a basis weight BW of paper is being adjusted, a basis weight adjustment unit 9 requests for a necessary fiber flow or machine stock KM flow to the paper machine 8, which depends on a consistency of the paper stock. The consistency of the paper stock fed into the wire section of the paper machine 8 typically varies between 0.3 and 1.5%. At an upper section 1a of the stock tower 1, where new first component stock OM1 is to be fed, the consistency of component stock OM1 is typically 10 to 14%. Thus, the first component stock OM1, as well as typically also the second and third component stocks OM2, OM3, have to be diluted before being pumped to the paper machine 8. The component stocks OM1, OM2 and OM3 are diluted by addition of dilution water into the stock in such a manner that the consistency of the machine stock KM to be fed in due course into a short circulation of the paper machine 8 is about 3%.

FIG. 2 further shows the dilution of the first component stock OM1 with dilution water fed immediately after the stock tower 1 at a blending point DP1 to the suction side of the first pump P1 via an adjusting valve V1 and a dilution water duct DW1. At this point, the consistency of the stock is diluted from a consistency level of 10 to 14% to a level of 5 to 6%. After the component stock chest 3, the first component stock OM1 is further diluted with dilution water fed at a blending point DP2 to the suction side of the second pump P2 via an adjusting valve V2 and a dilution water duct DW2, typically to a level of 3.2 to 3.5%. The component stock dosing line may comprise a plurality of successive component stock chests and, after them, blending points, but for the sake of clarity FIG. 2 only shows one component stock chest 3. One more stock dilution step is usually arranged between the physically separate blending and machine chests. The first component stock OM1 can also be diluted in a lower section 1b of the stock tower 1 by recycling the stock and adding dilution water to the first component stock OM1 at a blending point DP3 via an adjusting valve V3 and a dilution water duct DW3.

FIG. 3 is a schematic view of a first auxiliary process page window 106 for displaying a graphical illustration of a subprocess 107 of the industrial process 101, the subprocess 107 in this example being a dilution process for dilution of the first component stock OM1 flowing out of the stock tower 1. FIG. 4 is a schematic view of a second auxiliary process page window 108 for displaying a graphical illustration of a process component 109 of the industrial process 101, the process component 109 being in this example the stock tower 1.

The stock production and dosing line 10 for the paper machine 8, as well as the paper machine 8, disclosed in FIGS. 2, 3, 4 provides only an example of an industrial process environment wherein the industrial process control system described herein may be utilized. The actual operation of the stock production and dosing line 10 or the paper machine 8 is not relevant for the solution described herein. Therefore the actual operation of the stock production and dosing line 10 or the paper machine 8 or actual monitoring or control operations therein are not considered herein in more detail.

At least one of the main process page window 105, the first auxiliary process page window 106 and the second auxiliary process page window 108 further comprises at least one operator configurable region 110 to be displayed at the respective process 101, subprocess 107 and/or process component 109 for visualizing information describing the operation of the process 101, subprocess 107 and/or process component 109 in response to a selection of the information to be displayed.

In the process page window 105, 106, 108 the operator configurable region 110 may be located on top of the respective process 101, subprocess 107 and/or process component 109 such that the process 101, subprocess 107 and/or process component 109 is at least partly visible through the operator configurable region 110.

Alternatively the operator configurable region 110 may be located next to the respective process 101, subprocess 107 and/or process component 109b, like schematically presented in FIGS. 2, 3, 4. The location of the operator configurable region 110 in the process page window 5, 6, 8 may be freely selectable by the operator. The location of the operator configurable region 110 in the process page window 105, 106, 108 may be altered for example by dragging the operator configurable region 110 in the process page window 105, 106, 108 with a mouse connected to the process control computer or by numerically defining in a selection menu the location of the operator configurable region 110 in the process page window 105, 106, 108.

In the process page windows 105, 106, 108 of FIGS. 2, 3 and 4 the operator configurable region 110 is shown to be limited by boundaries provided by straight visible lines. However, many alternative embodiments for providing the operator configurable region 110 is available. According to an embodiment, the operator configurable region 110 is only a region in the process page window 105, 106, 108 wherein the boundaries of the operator configurable region 110 are not visible. In both of these cases, at least when the operator configurable region 110 is located at least partly on top of the process 101, subprocess 107 and/or process component 109 in the respective process page window 105, 106, 108, the details of the graphical illustration of the process 101, subprocess 107 and/or process component 109 are visible through the operator configurable region 110 in the areas of the operator configurable region 110 wherein the operator configurable region 110 does not comprise any textual, numerical, graphical or in some other way presented information.

According to an embodiment the information to be presented in the operator configurable region 110 is presented by utilizing screening whereby every other pixel being visible belongs to the operator configurable region 110 for presenting the information to be presented in the operator configurable region 110 and every other pixel belongs to the process page window 105, 106, 108 for presenting the details of the graphical illustration of the process 101, subprocess 107 and/or process component 109. According to an embodiment the operator configurable region 110 is laid on top of the respective process 101, subprocess 107 and/or process component 109 such that the details of the graphical illustration of the process 101, subprocess 107 and/or process component 109 remaining under the operator configurable region 110 are not visible. The operator configurable region 110 provides for the operator a portion in the process page window 105, 106, 108, wherein the operator may freely inspect and/or supply information relating to the respective process 101, subprocess 107 and/or process component 109. In the operator configurable region 110 the operator may also define which process monitoring information is to be monitored and/or supplied in the respective operator configurable region 110.

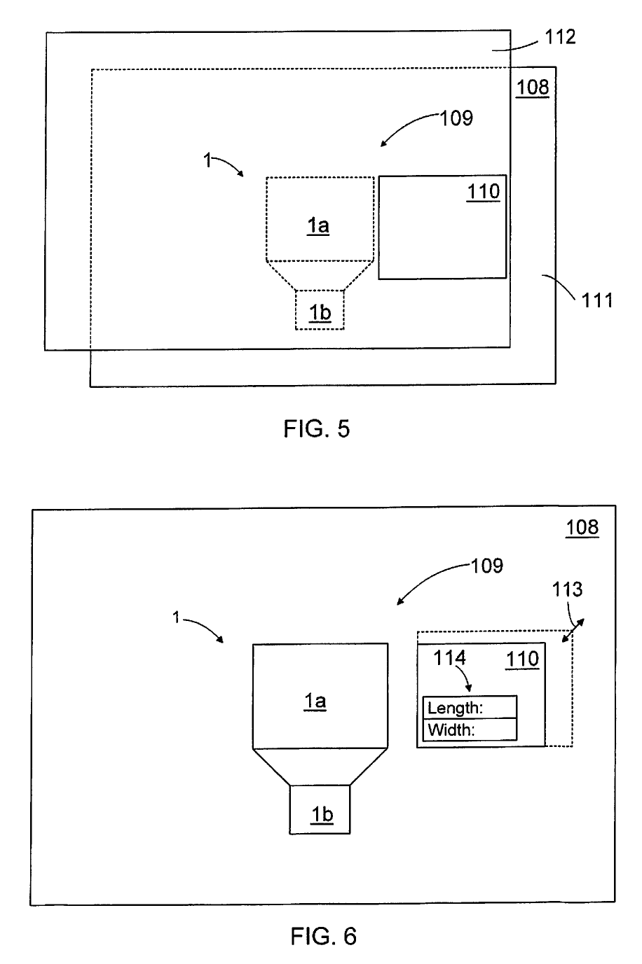

According to an embodiment the process page window 105, 106, 108 comprising at least one operator configurable region 110 comprises a first layer 111 and a second layer 112, wherein the second layer 112 is at least partly superimposed on top of the first layer 111. According to this embodiment the first layer 111 is arranged to comprise the industrial process 101, subprocess 107 and/or process component 109 and the second layer 112 is configured to comprise the operator configurable region 110 to be displayed at the respective process 101, subprocess 107 and/or process component 109. In FIG. 5 it is shown schematically a second auxiliary process page window 108 comprising a first layer 111 and a second layer 112 on top of the first layer 111, wherein the first layer 111 comprises the process component 109, i.e. the stock tower 1. The second auxiliary process page window 108 and the stock tower 1 therein are shown in FIG. 5 partly with a broken line, illustrating the position of the first layer 111 behind or underside the second layer 112.

According to an embodiment the layered structure of the process page window 105, 106, 108 may be implemented at a time of a creation of the operator configurable region 110 in the process page window 105, 106, 108.

The layered structure of the process page window 105, 106, 108 provides for example an effect or an advantage that it is not possible to amend or change accidentally the actual graphical illustration of the respective process 101, subprocess 107 and/or process component 109 when the content of the operator configurable region 110 is to be determined or established.

According to an embodiment, at least one of a size and shape of the operator configurable region 110 is changeable in response to an operation of the operator to change the at least one of the size and shape of the operator configurable region 110. The size and/or shape of the operator configurable region 110 may be changed or altered by gripping with a pointer of the mouse to a side or a corner of the operator configurable region 110 and dragging thereafter the pointer along the respective process page window 105, 106, 108, in a direction shown by an arrow 113, for example. According to another embodiment it may be numerically defined in a selection menu 114 the size and/or shape of the operator configurable region 110 in the process page window 105, 106, 108. In FIG. 6 it is schematically disclosed changing a size and/or shape of the operator configurable region 110 by the mouse or by numerically defining for example a height and a width of the operator configurable region 110 in the selection menu 114 in the operator configurable region 110.

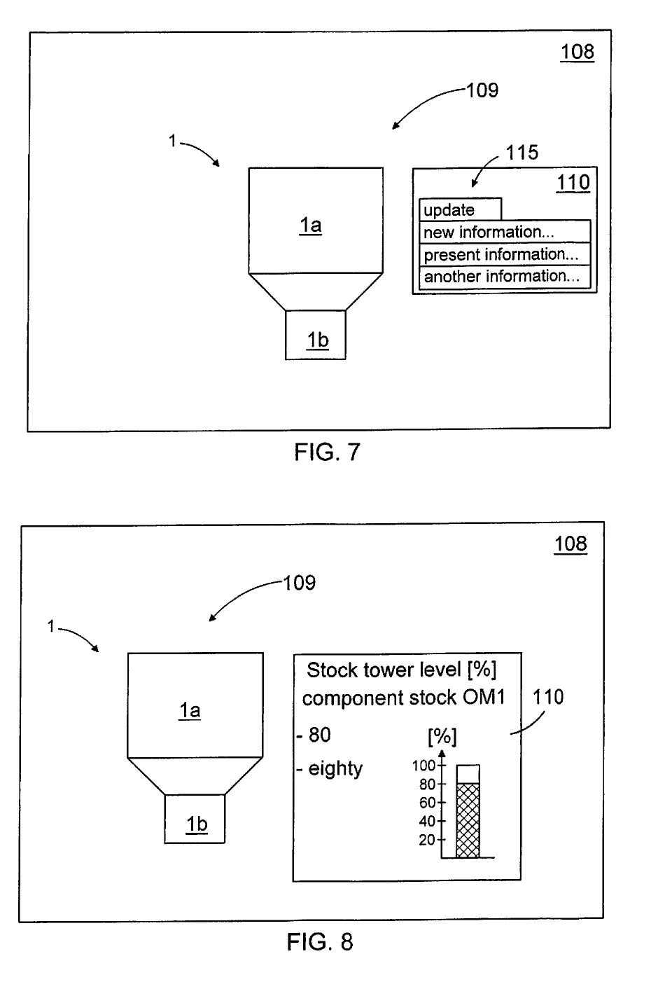

According to an embodiment a content of the operator configurable region 110 is configured to be updated in response to an operation of the operator to update the content of the operator configurable region 110. In this embodiment the update of the content of the operator configurable region 110 may concern on a supply of new information to be presented in the operator configurable region 110, a change in the subject matter or information to be displayed in the operator configurable region 110 or updating the content of the information presently displayed in the operator configurable region 110. In FIG. 7 it is schematically disclosed in the operator configurable region 110 a selection menu 115 with options either to update the present information displayed in the operator configurable region 110 or to another information to be presented in the operator configurable region 110.

There are several alternative ways to supply into the operator configurable region 110 the information to be presented in the operator configurable region 110, which information is to be supplied into the operator configurable region 110 by the operator. According to an embodiment that information may be supplied into the operator configurable region 110 by typing using a keyboard and possible the mouse that belong to the process control user interface 102. According to another embodiment that information may be supplied into the operator configurable region 110 orally, whereby the process control user interface 102 comprises a microphone for recording the speaking of the operator and a voice recognition software for translating the speaking of the operator into the textual and/or numerical form.

According to an embodiment the operator configurable region 110 comprises a selection menu 116 for selecting a way of presentation of the information to be displayed in the operator configurable region 110 in response to a selection of an operator. Different ways for the presentation of the information may comprise numerical data, a single diagram or a set of time dependent diagrams, a bar diagram, textual form, etc. In FIG. 8 it is schematically disclosed an operator configurable region 110 for the second auxiliary process page window 108 for the stock tower 1, wherein the operator configurable region 110 shows a level of the first component stock OM1 in the stock tower 1 with a numerical data, a bar diagram and textual form as per cents relative to the full level of the component stock OM1 in the stock tower 1.

According to an embodiment the selecting of the way of presentation of the information to be displayed in the operator configurable region 110 or the selecting of which information is to be displayed in the operator configurable region 110 may be provided orally, whereby the speaking of the operator is recorded by the microphone and the voice recognition software translates the speaking of the operator into a form of an order for the selection of the way of the presentation of the information to be displayed in the operator configurable region 110 or the selection of which information is to be displayed in the operator configurable region 110 for the textual and/or numerical form.

In the examples above it is assumed that the operator configurable region 110 is always present or visible in the process page window 105, 106, 108 or in the additional layer of the process page window 105, 106, 108. According to an embodiment the operator configurable region 110 is retrieved into the process page window 105, 106, 108 in response to a request presented by the operator. The operator may carry out that request through the keyboard or by the mouse or orally, for example. After the operator has examined the information presented in the operator configurable region 110, the operator may close or remove the operator configurable region 110 from the view of the process page window 105, 106, 108 either by a respective operation provided through the keyboard or by the mouse. The operator configurable region 110 may also be closed or removed from the view of the process page window 105, 106, 108 in response to an oral request presented by the operator. The operator configurable region 110 may also be closed or removed from the view of the process page window 105, 106, 108 in response to an operator not focusing his/her look at the operator configurable region 110 anymore or by for example presenting a sweeping movement by his/her hand, which can be detected by a camera and a gesture recognition software forming part of the process control user interface 102. These methods for retrieving and closing the operator configurable region 110 may be applied when the operator configurable region 110 is to be displayed on the same layer as the industrial process 101, subprocess 107 and/or process component 109 or in the additional layer to be laid on top of that layer where the industrial process 101, subprocess 107 and/or process component 109 are presented.

The operator configurable region 110, despite of it is intended to be presented either on the same layer where the industrial process 101, subprocess 107 and/or process component 109 are presented or in the additional layer to be laid on top of that layer where the industrial process 101, subprocess 107 and/or process component 109 are presented, is simple and fast to create or retrieve and simple and fast to remove or close, whereby it is possible to obtain or acquire quickly additional information momentarily and context-sensitively.

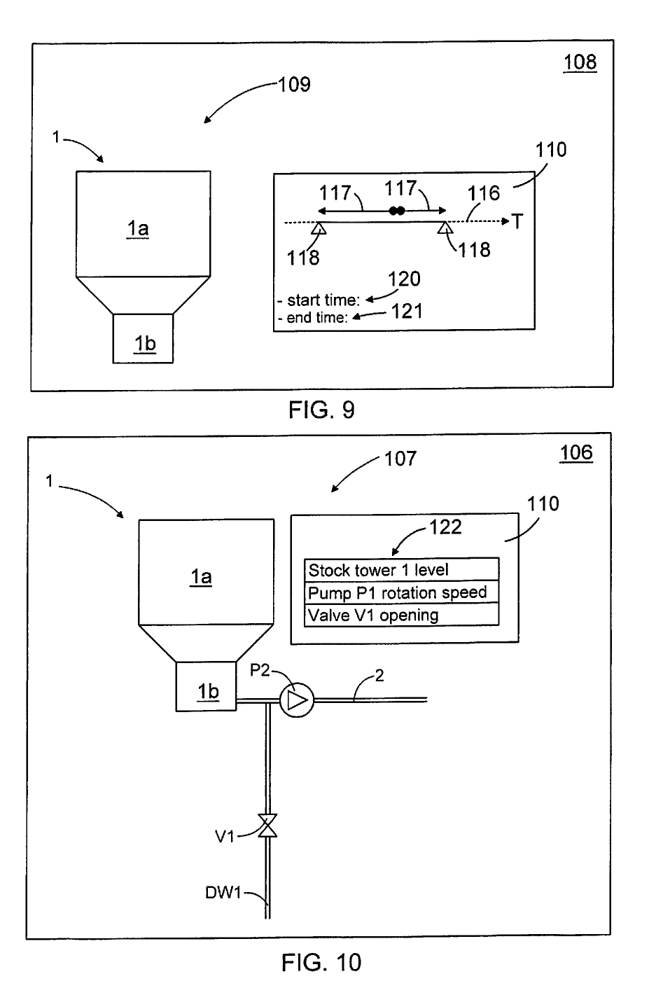

According to an embodiment the operator configurable region 110 comprises different selectors for determining in a time line 116 a time period at a time of which the information to be monitored is to be displayed in the operator configurable region 110 in response to a selection of the operator. The selector may for example comprise markers 117 that can be extended or shortened, ormovable markers 118, 119 on the time line 118 for indicating start and end times for the time period under interest, or positions for numerical values indicating the start 120 and end 121 times for the time period under interest. In FIG. 9 it is schematically disclosed an operator configurable region 110 comprising the features listed above.

The operator configurable region 110 comprising the time line 116 and different selectors therein may be utilized in any process page window. Furthermore, according to an embodiment the operator configurable region 110 comprising the time line 116 and different selectors therein may be included in the main process page window 105 such that the time line 116 with different selectors are linked to the other process page window, i.e. in this example to the first 106 and second 108 auxiliary process page windows. Thereby, moving the selectors in the time line 116 in the main process page window 105 causes both that the information intended to be presented in the main process page window 105 is shown only of the during of that time period and that the information intended to be presented in the auxiliary process page windows 106, 108 is shown only of the during of that same time period.

According to an embodiment different kind of indicators 126 may be embedded into the process page windows 105, 106, 108 so as to indicate or highlight process control operations or other events that have taken place during the time period selected by selectors forming part of the time line 116. These indicators have been schematically shown in FIG. 2 at the first pump P1 and the valve vi.

According to an embodiment, at least one of the process page windows 105, 106, 108 comprises at least one operator configurable region 110 and the operator configurable region 110 further comprises a selection menu 122 for selecting particular information to be displayed in the operator configurable region 110 in response to a selection of a respective selection option in the selection menu 122. The selection menu 122 may thus comprise a number of selection options or items for selecting the subject matter about which the information is to be presented. Additionally the selection menu may comprise selection options for selecting the way how the information is to be presented, such as numerical, graphical or textual presentation as already mentioned above. In FIG. 10 it is schematically disclosed as an example an operator configurable region 110 for the first auxiliary process page window 106, the operator configurable region 110 comprising the selection menu 122 with items “stock tower level”, “pump P1 rotation speed” and “valve V1 opening”.

The information to be displayed in the operator configurable region comprises various process data. The process data may describe for example measurement information relating to the industrial process 101, subprocess 107 or process component 109. The process data may also describe for example setup information relating to the industrial process 101, subprocess 107 or process component 109. The process data may also describe for example control information relating to the industrial process 101, subprocess 107 or process component 109. The process data may also describe for example notes relating to the industrial process 101, subprocess 107 or process component 109. The process data may also describe for example alarm information relating to the industrial process 101, subprocess 107 or process component 109.

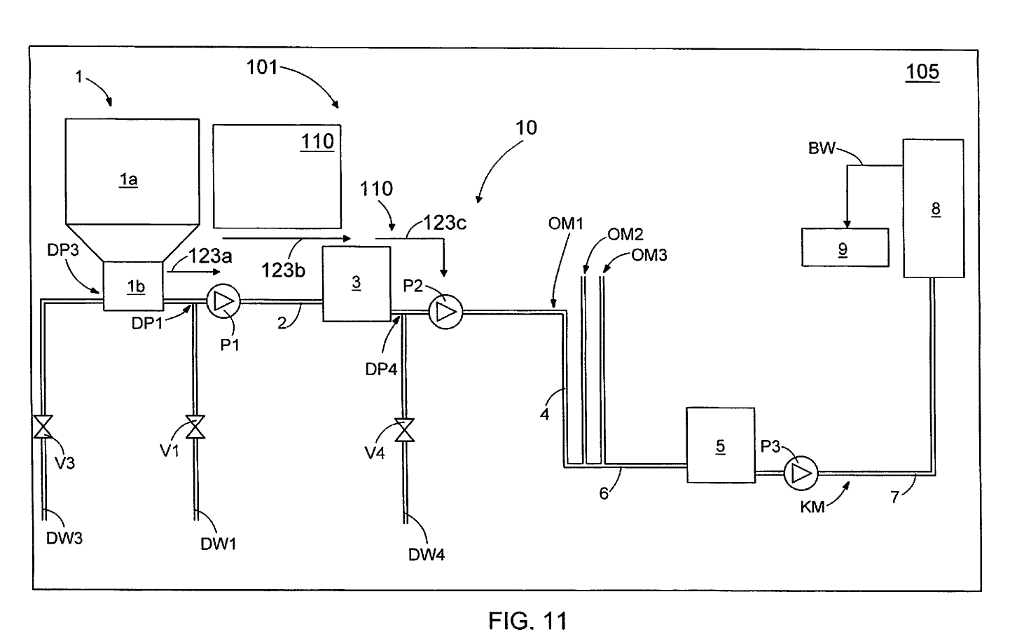

The alarm information may comprise a visual representation of an alarm chain of interdependent alarms taken place in the industrial process 101, subprocess 107 or process component 109. The visual representation of the alarm chain of the interdependent alarms may comprise a number of successive pointers 123a, 123b, 123c, such as arrows. The pointer 123a starts from a position of the industrial process 101, subprocess 107 or process component 109 where the at least one malfunction initiating the alarm was appeared and ending to a position of the industrial process 101, subprocess 107 or process component 109 where the malfunction initiating the first alarm initiated at least one subsequent second alarm. In FIG. 11 it is schematically disclosed as an example relating to the alarms the main process page window 105 illustrating the industrial process 101 and a first pointer 123a indicating a malfunction in the stock tower 1. The first pointer 123a extends from the stock tower 1 up to the first pump P1, where after a certain time another malfunction indication a malfunction in pump P1 is to be initiated, as schematically presented by a second pointer 123b, the second pointer 123b extending from the first pump P1 up to the component stock chest 3. After a certain time period a new malfunction is to be initiated at the component stock chest 3, unless the malfunctions at the first pump P1 and at the stock tower 1 are remedied. Possible malfunction at the component stock chest 3 is presented schematically by a third pointer 123c extending from the component stock chest 3 to the second pump P2. Each pointer 123a, 123b, 123c may be implemented by additional operator configurable regions 110 provided in the main process window 105, i.e. there may be special operator configurable regions 110 provided in the main process window 105 and intended for alarms indicating malfunctions in the industrial process 101.

According to an embodiment the industrial process control system and the graphical user interface 102 therein is configured to, in response to a respective command received, to take a snap-shot comprising at least one information describing the operation of the process 101, subprocess 107 or process component 109 and to store the snap-shot taken into a data storage forming part of the industrial process control system.

Furthermore, according to an embodiment at least one previously taken snap-shot is retrieved from the data storage and the last snap-shot taken is compared to at least one previously taken snap-shot retrieved from the data storage by arranging one snap-shot on top of another, for example. This provides a possibility to compare values of different variables at different time instants, for example.

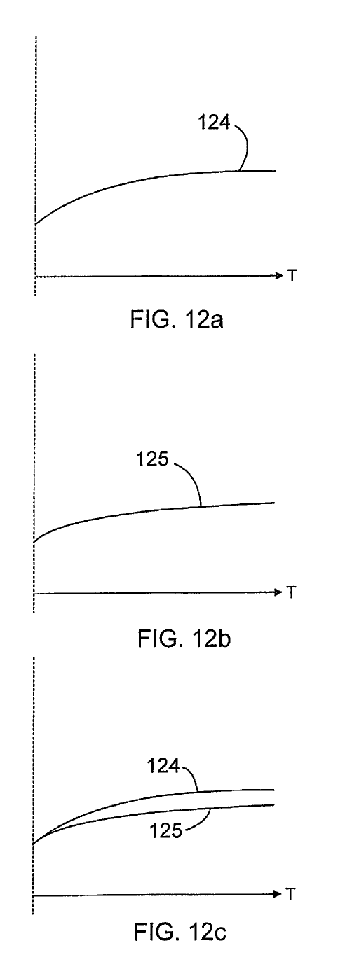

As an example of this FIG. 12a discloses schematically a snap-shot of an operator configurable region 110 comprising a graph 124 representing a value of a controllable variable during a time period, for example. FIG. 12b, in turn, discloses schematically another snap-shot of the same operator configurable region 110 comprising another graph 125 representing the value of the same controllable variable but during a different time period of same length. In FIG. 12c, in turn, the snap-shots taken are arranged one snap-shot on top of the other snap-shot for comparing the values of the same controllable variable at different time instants.

In the example of the preceding paragraph the snap-shots were used for comparing graphs 124, 125 representing the value of the controllable variable during different time periods. Alternatively the snap-shots may be taken from the process page windows and used for comparing operating positions of process components at different time instants, for example.

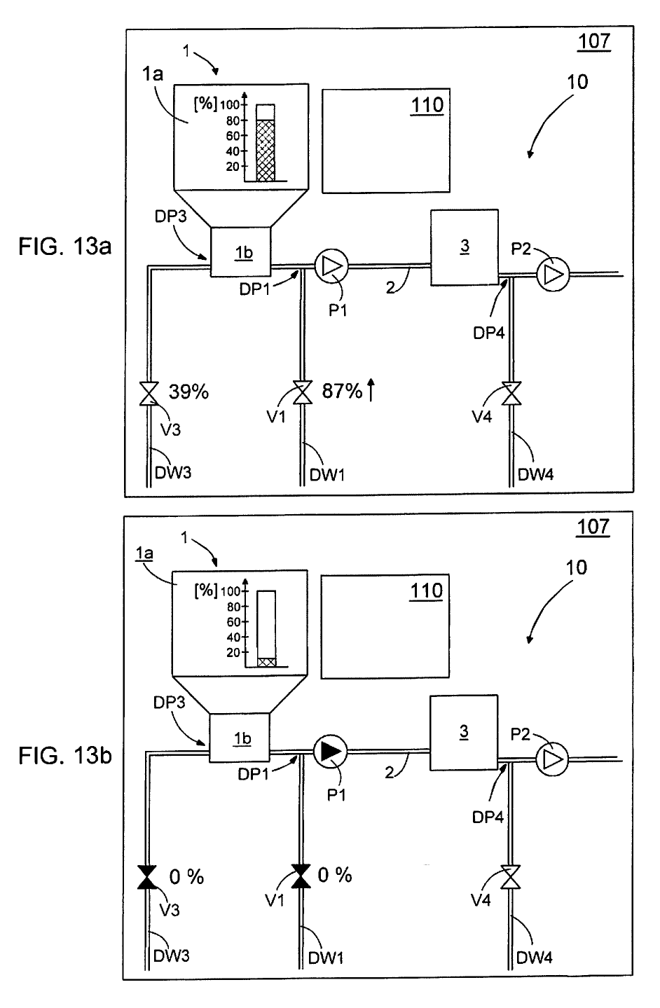

FIGS. 13a and 13b disclose schematically a comparing of snap-shots of a subprocess 107 at different time instants for comparing operating positions of process components at different time instants. In this example a beginning of the stock preparation department comprising the stock tower 1, the component stock chest 3, valves V1, V2, V4 and pumps P1, P2 are considered to provide the subprocess 107 of this example.

FIG. 13a discloses a snap-shot taken at a time instant describing a normal process operation situation. In FIG. 13a the stock level in the stock tower 1 is about 80%, an opening of the valve V3 is 39%, an opening of the valve V1 is 87% and increasing as indicated by an upwards pointing arrow next to the value describing the opening of the valve V1.

FIG. 13b discloses a snap-shot taken at a later time instant describing a situation relating to a change of a paper grade to be manufactured, for example. In FIG. 13b the stock level in the stock tower 1 is only about 10% because the supply of the first component stock OM1 to the stock tower 1 has been stopped. Also the supply of the first component stock OM1 to the component stock chest 3 is stopped by stopping the operation of the pump P1, which is indicated by turning the inner symbol in the symbol of the pump P1 to black. Also the supply of the dilution water from the dilution water ducts DW1, DW3 is stopped by closing the valves V1, V3. This in indicated by turning the symbol of the valves V1, V3 to black and numerically indicating the opening of the valves V1, V3 to be 0%. By updating the symbol appearance, for example, the operating situation of specific process component may be quickly observed. Different symbols for indicating a specific process component being under local manual control, under automatic control or under remote control may also be applied, as well as for the process component being under service operations and therefore not available, may also be applied.

In the example of FIGS. 13a, 13b the snap-shot of FIG. 13a is laid above the snap-shot of FIG. 13b, but the snap-shots of FIGS. 13a, 13b could also be at least partly superimposed, for example in such a way that the snap-shot of FIG. 13a of earlier time instant is at least partly laid under the snap-shot of FIG. 13b of later time instant. In this case the symbols belonging to the snap-shot of FIG. 13a of earlier time instant may be partly faded out so as to increase the readability of the snap-shots of different time instants.

In the example of FIGS. 13a, 13b it is possible to compare with only a single or few glances differences between the operating situations and operating positions of process components at different time instants, for example.

It will be obvious to a person skilled in the art that, as the technology advances, the inventive concept can be implemented in various ways. The invention and its embodiments are not limited to the examples described above but may vary within the scope of the claims.

1. An industrial process control system comprising a graphical user interface for monitoring and controlling an operation of an industrial process, the graphical user interface comprising:
a main process page window for displaying a graphical illustration of the industrial process,
a group of auxiliary process page windows, at least some of the auxiliary process page windows being arranged to display a graphical illustration of at least one subprocess or at least one process component of the industrial process,
wherein the graphical illustration of the industrial process, at least one subprocess or at least one process component is operationally connected to the respective process, subprocess or process component for providing at least one of monitoring and controlling of an operation of the respective process, subprocess or process component through the respective graphical illustration of the graphical user interface, and wherein
at least one process page window comprises at least one operator configurable region to be displayed at the respective process, subprocess or process component for visualizing information describing the operation of the process, subprocess or process component in response to a selection of the information to be displayed.

2. An industrial process control system as claimed in claim 1, wherein the process page window comprising the at least one operator configurable region comprises a first layer and a second layer to be at least partly superimposed on top of the first layer, and that the first layer is arranged to comprise the industrial process, subprocess or process component and the second layer is configured to comprise the operator configurable region to be displayed at the respective process, subprocess or process component.

3. An industrial process control system as claimed in claim 1, wherein at least one of a size and shape of the operator configurable region is changeable in response to an operation of an operator to change the at least one of the size and shape of the operator configurable region.

4. An industrial process control system as claimed in claim 1, wherein a content of the operator configurable region is to be updated in response to an operation of an operator to update the content of the operator configurable region.

5. An industrial process control system as claimed in claim 1, wherein the operator configurable region comprises at least one first selector for selecting a way of presentation of the information to be displayed in the operator configurable region in response to a selection of an operator.

6. An industrial process control system as claimed in claim 1, wherein the operator configurable region comprises at least one second selector for determining a time period during which time period the information taken place is to be displayed in response to a selection of an operator.

7. An industrial process control system as claimed in claim 1, wherein at least one of the process page windows comprises the at least one operator configurable region and the operator configurable region further comprises a selection menu for selecting particular information to be displayed in the operator configurable region in response to a selection of a respective selection option in the selection menu.

8. An industrial process control system as claimed in claim 1, wherein the information to be displayed in the operator configurable region comprises process data describing at least one of:
measurement information relating to the industrial process, subprocess or process component;
setup information relating to the industrial process, subprocess or process component;
control information relating to the industrial process, subprocess or process component;
notes relating to the industrial process, subprocess or process component;
alarm information relating to the industrial process, subprocess or process component.

9. An industrial process control system as claimed in claim 8, wherein the alarm information comprises a visual representation of an alarm chain of interdependent alarms taken place in the industrial process, subprocess or process component.

10. An industrial process control system as claimed in claim 9, wherein the visual representation of the alarm chain of the interdependent alarms comprises a number of successive pointers, wherein each pointer starts from a position of the industrial process, subprocess or process component where the at least one malfunction initiating the alarm was appeared and ending to a position of the industrial process, subprocess or process component where the malfunction initiating the first alarm initiated at least one subsequent second alarm.

11. An industrial process control system as claimed in claim 1, wherein the industrial process control system is configured to, in response to a respective command received, to take a snap-shot comprising at least one information describing the operation of the process, subprocess or process component and to store the snap-shot taken into a data storage forming part of the industrial process control system.

12. A method of generating a process page window in an industrial process control system comprising a graphical user interface for monitoring and controlling an operation of an industrial process, wherein the graphical user interface comprises:
a main process page window for displaying a graphical illustration of the industrial process,
a group of auxiliary process page windows, at least some of the auxiliary process page windows being arranged to display a graphical illustration of at least one subprocess or at least one process component of the industrial process,
wherein the graphical illustration of the industrial process, at least one subprocess or at least one process component is operationally connected to the respective process, subprocess or process component for providing at least one of monitoring and controlling of an operation of the respective process, subprocess or process component through the respective graphical illustration of the graphical user interface, and in which method
at least one operator configurable region to be displayed at the respective process, subprocess or process component for visualizing information describing the operation of the process, subprocess or process component in response to a selection of the information to be displayed is generated in at least one process page window, and
the process page window comprising the configurable window is stored into the group of the process page windows in the graphical user interface.

13. A method as claimed in claim 12, wherein the process page window comprising the at least one operator configurable region is configured to comprise a first layer and a second layer to be at least partly superimposed on top of the first layer, and that the first layer is configured to comprise the industrial process, subprocess or process component and the second layer is configured to comprise the operator configurable region to be displayed at the respective process, subprocess or process component.

14. A method as claimed in claim 12, comprising displaying in the operator configurable region at least one second selector for determining a time period during which time period the information taken place is to be displayed in response to a selection of an operator.

15. A method as claimed in claim 12, comprising selecting in a selection menu in at least one of the process page windows comprising the at least one operator configurable region and the operator configurable region particular information to be displayed in the operator configurable region in response to a selection of a respective selection option in the selection menu.

16. A method as claimed in claim 12, wherein the information to be displayed in the operator configurable region comprises process data describing at least one of:
measurement information relating to the industrial process, subprocess or process component;
setup information relating to the industrial process, subprocess or process component;
control information relating to the industrial process, subprocess or process component;
notes relating to the industrial process, subprocess or process component;
alarm information relating to the industrial process, subprocess or process component.

17. A method as claimed in claim 16, wherein the alarm information comprises a visual representation of an alarm chain of interdependent alarms taken place in the industrial process, subprocess or process component.

18. A method as claimed in claim 17, wherein the visual representation of the alarm chain of the interdependent alarms comprises a number of successive pointers, wherein each pointer starts from a position of the industrial process, subprocess or process component where the at least one malfunction initiating the alarm was appeared and ending to a position of the industrial process, subprocess or process component where the malfunction initiating the first alarm initiated at least one subsequent second alarm.

19. A method as claimed in claim 12, wherein a snap-shot comprising at least one information describing the operation of the process, subprocess or process component is taken in response to a respective command received and the snap-shot taken is stored into a data storage forming part of the industrial process control system.

20. A method as claimed in claim 19, wherein a snap-shot comprising at least one information describing the operation of the process, subprocess or process component is taken in response to a respective command received, at least one previously taken snap-shop is retrieved from the data storage and the last snap-shot taken is compared to at least one previously taken snap-shot retrieved from the data storage.
